(19) United States
(12) Patent Application Publication
(10) Pub. No.: US 2010/0235306 A1
(43) Pub. Date: Sep. 16, 2010

(54) ADAPTIVE TIMELOG SYSTEM

(76) Inventor: Seth Wagoner, Christchurch (NZ)

Correspondence Address: CONNOLLY BOVE LODGE & HUTZ LLP, 1875 EYE STREET, N.W., SUITE 1100, WASHINGTON, DC, 20006, US

(21) Appl. No.: 12/619,194

(22) Filed: Nov. 16, 2009

Related U.S. Application Data
(63) Continuation of application No. 12/539,463, filed on Aug. 11, 2009, now abandoned.

(30) Foreign Application Priority Data
Aug. 11, 2008 (NZ) 570423

(51) Int. Cl. G06F 15/18; G06N 5/04

(52) U.S. Cl. 706/12

(57) ABSTRACT

An adaptive time log system that includes computer based systems and methods for monitoring, recording categorizing and reporting user activity on a timeline basis is provided.

### BACKGROUND OF THE INVENTION

1. Technical Field

The present invention pertains to time-logging applications. More particularly, this invention pertains to computer based systems and methods for monitoring, recording, categorising and reporting user activity on a timeline basis.

2. Description of related art

Tracking and reporting activity on a time basis has utility for understanding how individuals and teams are spending their time when logged onto a computer.

Software solutions exist for monitoring computer activity for a variety of reasons, such as tracking user activity by way of keystroke logging as a backup if hardware failure strikes, to enable review of industrial processes for identifying where faults occur, to track illegal or unauthorized use of computers, through to managing time.

Software solutions exist for time tracking, for applications such as project management and service based billing.

Software solutions exist for tracking user activity on a time basis, by uploading the monitored activity to a third party server for aggregation and reporting back to the user via a web interface, where minimal data entry is required by the user, such as www.rescuetime.com.

However there exists a need for an application that allows construction of a categorized timeline of user activity and associations which: accurately summarises user activity from multiple sources; operates directly on the client computer without needing to upload data to third parties, and; requires minimal input from the user.

Increasingly, knowledge work involves a constant combination of local and web based documents, along with various other sources of data, eg. an enterprise-wide document search, the user's email, or the user's contact list.

Interfaces now exist that allow for a flow of events within the user environment to be aggregated by a system service, typically to aid in the compilation of desktop search indexes. Two such interfaces are iNotify for Linux and the Google Desktop Event API for Microsoft Window.

It is an object of the present invention to define novel aspects relating to the method and system for constructing a timeline of user activity comprising multiple contexts and semantic associations with user roles, projects and tasks, which requires less effort on the part of the user than traditional time-logging applications and devices.

More detailed and contextual time reporting enables benefits such as:
Faster hand-over of projects/roles/clients, temporarily or permanently, and allowing for one person's projects/roles/clients in a firm to be transferred to different people without confusion about which projects and responsibilities are now associated with the person
Easier project sharing because the detailed timeline of the project and documents/locations/people associated with it can be visible to all members
Improved work/life separation
Better accounting of time spent on any given project for billing purposes
Better control of compensation when employees are part-time or flexi-time

An awareness of the user's current context, their history and future plans allows for:
Fine grained presence notifications, whereby some people are simply told you are not available, whilst others are advised of your current project, and so on
Automated call/email screening and replies with information about when the user will likely be able to respond

An awareness of the applications, contacts and documents associated with the user's current project, task and or role allows for:
A compact “dashboard” to be presented to the user for rapid access to the most relevant documents, applications, and contacts for that project/role/client.
A “virtual desktop” to be built up for the project which additionally comprises the documents and applications that are open and where they appear.
A set of documents to be opened or closed as a group
Rapid filing of new notes against a project, task, client and or role.
Quick access to relevant data for insertion into documents or notes

The association of keywords and phrases with the user's current project enables:
Rapid selection of the terms for searching purposes
Assisted recall of unusual terms for people with language difficulties
Automatic background searching (potentially combined with user's location)
Highlighting of items within a document or “linked from a document”, or highlighting, in an overlay of the user's environment or within a completely virtual environment.

Further aspects and advantages of the present invention will become apparent from the ensuing description and drawings, which are given by way of example only.

### DISCLOSURE OF INVENTION

According to one aspect of the present invention there is provided a method and apparatus for constructing a timeline of user activity including multiple contexts and semantic associations with a user's roles, projects and tasks, requiring much less interaction on the part of the user than traditional time-logging applications and devices.

The method involves elements including:
Gathering data from multiple applications, APIs, operating systems and devices in order to record information regarding user location, application and device in use, discussions and discussion members, documents “touched” and document fragments read, written, selected, edited or searched for within specific time periods—denoted “timeslices” in this application.
Derivation of weighted keyword/phrase lists from the documents, transcripts and document fragments associated with the Timeslices—deonoted “Termweights” in this application.
Using a weighted list of criteria matching rules for inferring the most likely Role/Project/Task (RPT) from a set of possibilities using the Timeslice context information and associated Termweights
Optionally, monitoring the performance of criteria scripts and updating them from a central server for the purpose of finding criteria that are both effective and efficient to calculate on the user's system.
Optionally, Storing information relating to personal matters using a different encryption key to information relating to work matters, thereby allowing for user privacy and the use of a single machine for both work and play.
Using a realtime feedback system to allow the user to confirm/correct inferences and to create new RPTs as appropriate, preferably giving the user a choice between the most likely alternatives for single-click ease of operation.
Using a retrospective review system to allow for confirming or correcting automated inferences by the user at a later stage
Building up of profiles of associated termweights and other contexts such as time, date and location for each RPT, where the profiles are much more greatly affected by confirmed inferences and new additions than they are by unconfirmed inferences
Re-weighting the inference criteria when user feedback indicates incorrect inferences were made, in favour of criteria that would have led to a correct inference;

Thus allowing the system to:
Give feedback and warnings to the user regarding their current level of focus fragmentation
Creating detailed time logs specific to users, roles or projects.
Make available timelines and user presence information that is filtered based on whether the request for information is from someone associated with one or another of the user's roles.
Rapidly store links and notes relating to a project or role other than the one the user wants to focus on, with sufficient metadata to be findable and useful later, without the user losing focus on the current task.
Make available a real-time context API for the purpose of allowing other applications to better support the user in their current role/project/task.
   Eg 1: A notification system could filter incoming alerts based on whether they are from someone associated with the user's current role, or contain keywords associated with the user's current task or project.
   Eg 2: Links to additional information could be inserted into a browser sidebar or toolbar, or even inserted directly into the user's viewed pages, whereby the linkage was guided by context associated with the user's Role/Project/Task, and therefore more likely to be useful than distracting.

### BRIEF DESCRIPTION OF DRAWINGS

This invention may also be said to broadly consist in the parts, elements and features referred to or indicated in the specification of the application, individually or collectively, and any or all combinations of any two or more of said parts, elements or features which have known equivalents in the art to which this invention relates, such known equivalents are deemed to be incorporated herein as if individually set forth.

Further aspects of the present invention will become apparent from the following description, which is given by way of example only and with reference to the accompanying drawings in which:

FIG. 1 is a Representation of a Timeline Display Dashboard

FIG. 2 is a Diagram of the System Structure

FIG. 3 is a Diagram of the Database Model

FIG. 4 is a Flow Diagram of the Context Change Confirmations

FIG. 5 is a Flow Diagram of the Criteria Matching Model

FIG. 6 is a Flow Diagram of the Criteria Re-weighting Model

FIG. 7 is a Flow Diagram of the Focus Fragmentation Warnings

### BEST MODES FOR CARRYING OUT THE INVENTION

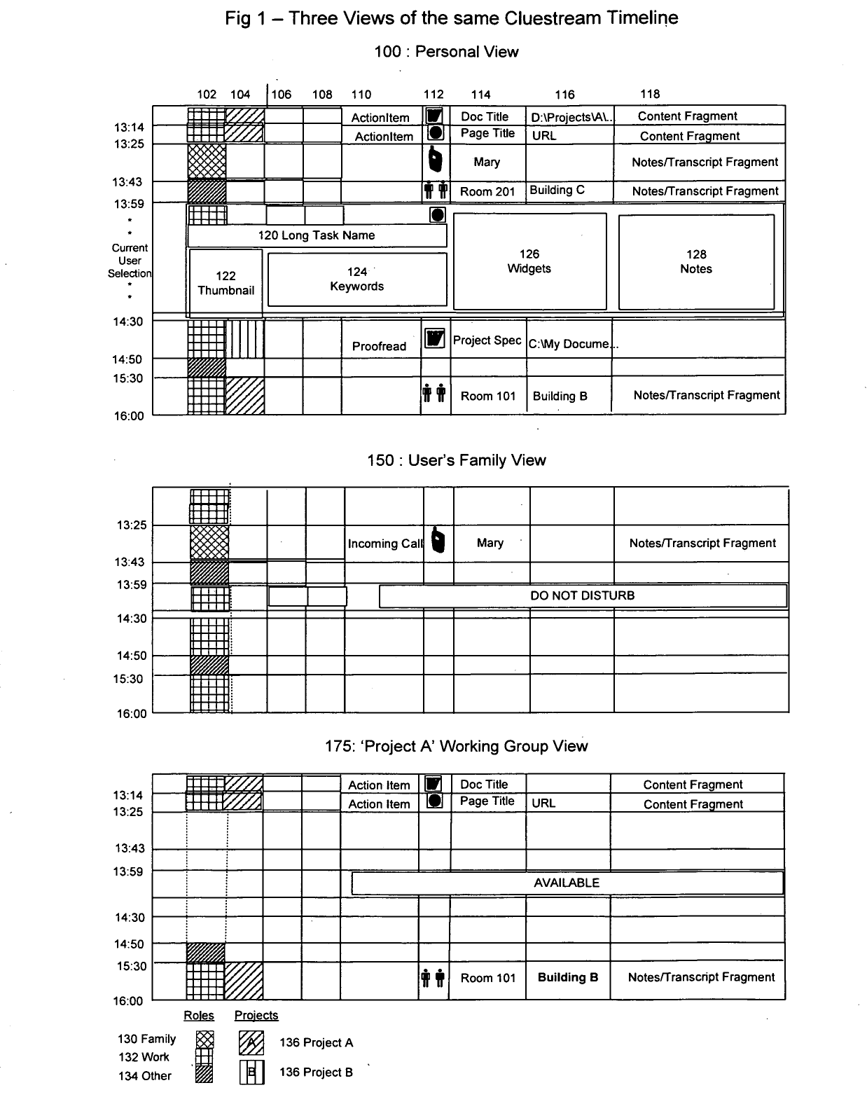

With Reference to FIG. 1

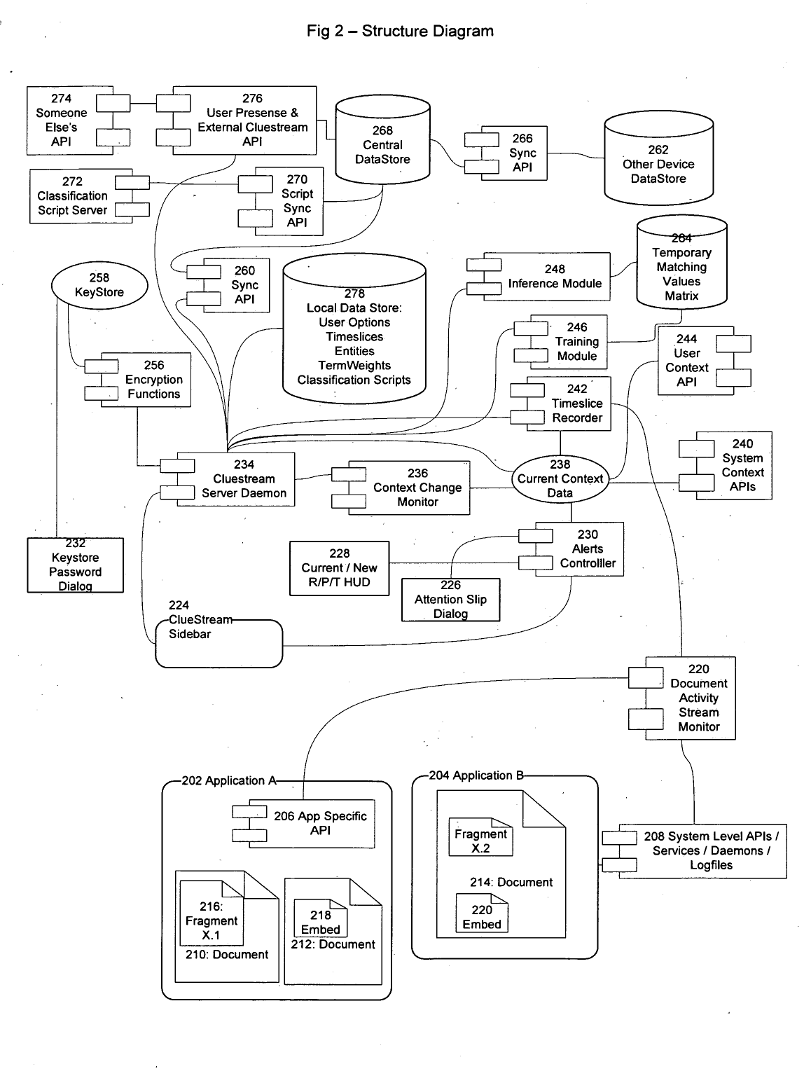

FIG. 1 Shows 3 different views of a part of one person's time stream, as composed from a TimeSlice Database (FIG. 2).

The First view (100) is a complete timeline visible to the user. The current task is open with extra information visible to give additional context. A history across multiple roles is visible above, and the plan for the rest of the day below.

The second view (150) is the timeline visible to the user's family. It hides much of the detail about what work the user is doing, and shows only the history items related to the family role, and the uncommitted timeslot later in the day. The user's current status is displayed as “Do not Disturb”

The third view (175) is the timeline visible to the user's partners on Project A. Details about the timeslices dedicated to Project Aare visible, as is the Slice later in the day when the user intends to attend a meeting related to Project A. The user's current status is displayed as “Available”

Each TimeSlice is displayed as a Row divided into several columns. Each column represents one of the various Contexts appropriate to that TimeSliceType. The most visible indication of the Timeslice Type is the Icon, or the icon typically used on that system for that specific type of Document, Application, or Event (eg Call, Meeting)

Another icon may represent either the person being contacted, or the favicon of the website visited.

The interface will ideally allow the user to filter on any given property, showing only those timeslices that are in a given Role/Project/Location/etc, or have keywords/content matching a given search string.

Each the vertical display size of each Timeslice is shown proportional to the timescale, indicated on the left, which changes so that a large time period can be shown at one time but the details only shown for a small part of it. Typically, the part in focus is the current day.

Periods of time that contain no timeslices matching the current filter can be collapsed even further, with no details given apart from the start and finish times.

The columns, representing different aspects of Timeslice metadata user context, can be removed or resized. The resize process should allow for different representations of the information, eg Icons and text can be used if there is enough room, otherwise colours and/or patterns will suffice, and these blend together across Timeslices to show which contexts are changing and which are not.

Any TimeSlice can be expanded into a detail view, which is currently shown for the Timeslice currently being created by User Activity.

The detail view may also display user interface “widgets” according to the user's preferences as to which “widgets” should be shown for each Timeslice type. 3^{rd} party widgets would ideally be rendered within an environment where it has access only to the context information the user has chosen to give to the widget, and it may access the internet for further information, if the user has chosen to allow that.

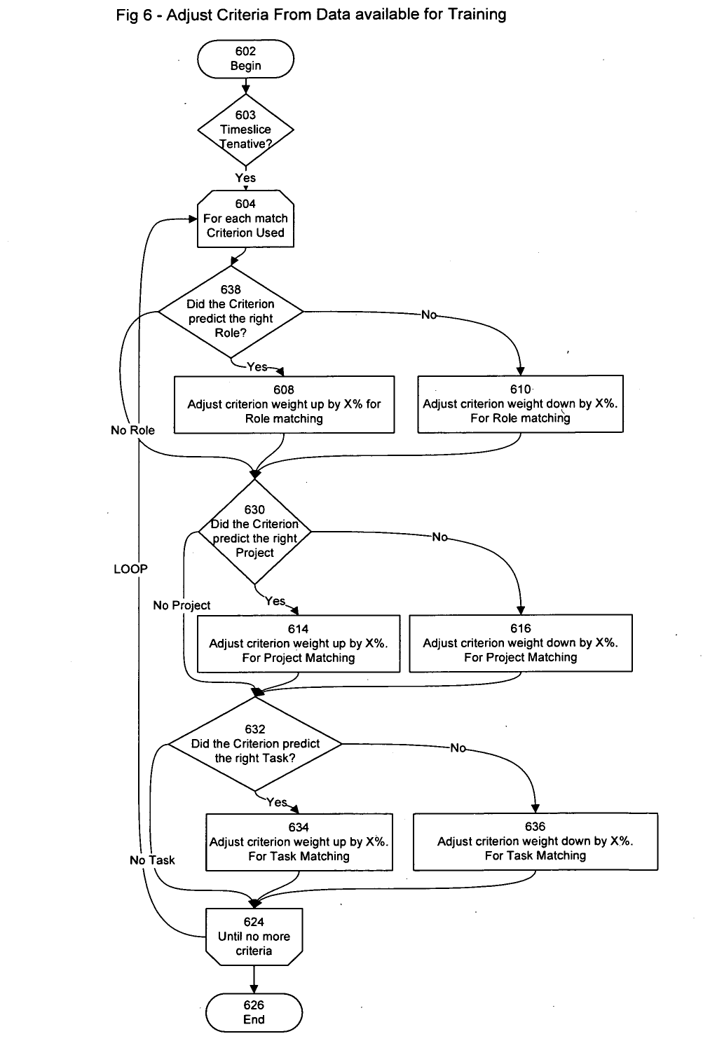

The detail view should allow the user to change the details where a Timeslice has record, or to confirm a tentative assignment of Role/Project/Task. This been incompletely or inaccurately may cause retraining of the classifier system (FIG. 6).

With Reference to FIG. 2

This shows the components of the system.

Monitored Files and Applications:

In order to derive the necessary semantic value from the documents being touched to drive the inference system, it is necessary to gather as much information as possible about the user's interaction with the documents, webpages, emails, and other applications. This can best be done through a combination of application specific plugins, and monitoring changes within the operating system. In this diagram we provide two examples, labeld Application A and Application B.

For Application A: The App Specific API is able to monitor the scrolling, keyboard, and mouse actions within the application sufficient to report attention time in detail including time spent looking at specific page fragments and embeds.

For Application B: Because there is no App-Specific API for this application it is necessary to rely on the Operating System APIs to determine information such as when the document is opened and closed, the user idle time, whether the application has focus, and when the document is saved (allowing for the possibility of detecting changes in the document). This allows for the derivation of information regarding time spent reading/writing/editing the document.

Documents

Many applications deal with the display or editing of “documents”, eg a word processor, or a web browser.

Two common scenarios are an application that holds multiple documents open at the same time, and displaying documents that contain other documents/medial embedded within them. In both cases it is extremely useful to be able to distinguish exactly which document the user is paying attention to, so that the context from the document can be captured.

Application (A) is a MDI/Tabbed application (eg a web browser) containing two documents. One document contains a text fragment (X.1) that happens to contain the same text as fragment (X.2) in another document. The other document contains an embedded item.

Application (B) is a SDI (Single Document Interface) displaying one document, it has a fragment (X.2) and an Embed.

Document Fragments

A common case is where one sees a quote from or the beginning of a document in one location and then clicks through to read the rest of the document. This is most common in the case of partial syndication feeds. It would be desirable to note when the user's “attention” belongs to a specific fragment and not the parent document—this is difficult—it would be easier with an eye tracking interface, but lacking that, one could assume that if the only thing on the screen was that fragment then the user was paying attention to it, if their mouse moved within it then they were probably paying attention to it, and if they clicked through from it, particularly if the clickthrough went to a document containing a similar fragment, then the user was probably paying attention to it.

The Document Activity Monitor receives information from the Operating System APIs and the Application APIs. Whenever it detects that some item of context has changed, it updates the current context, creates a new Timeslice, and passes the old Timeslice (IS) Record to Cluestream Server Daemon which stores it in the Local Datastore on the Device, which contains Timeslices, Entities, and User Options.

The Cluestream Server Daemon may also connect with a central datastore, or other cluestream datastores via P2P connections, to synchronize timeslices across devices, perform backups, and collaborate with others.

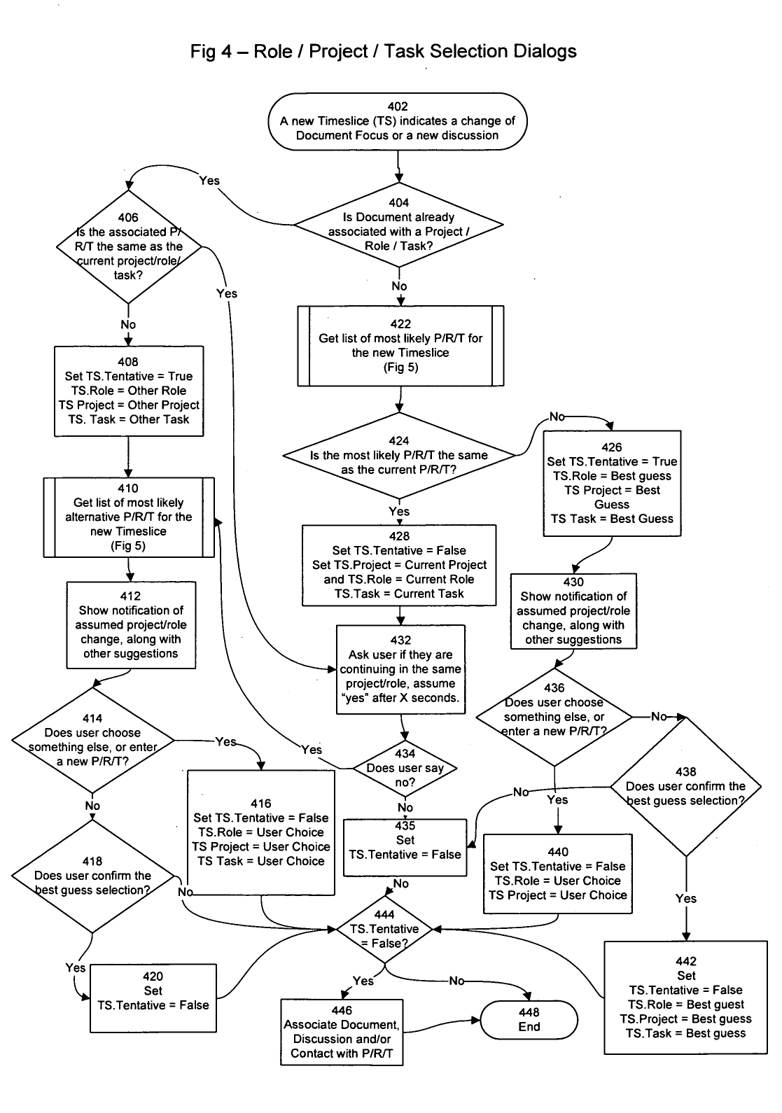

When the Alerts Controller detects a change of Document context it creates a new Timeslice and prompts the user with dialogs to find out if it needs to change the project/role context for that timeslice. This is covered in FIG. 4.

The automatic matching between user context, documents, and the user's collection of Roles, Projects, and Tasks, is done by the Inference Module, as controlled by the main Server Daemon.

The resulting detailed timeslice records should he protected by encryption for user privacy. In the displayed system, this is done using an external encryption module, eg using RSA/AES Hybrid encryption. For additional user privacy different roles may make use of different encryption keys.

From time to time the Training Module will examine the results of inference process and re-weight the criteria scripts based on their effectiveness. This is covered in FIG. 6. In an advanced system, new scripts may be downloaded from an external server and evaluated for their effectiveness and performance.

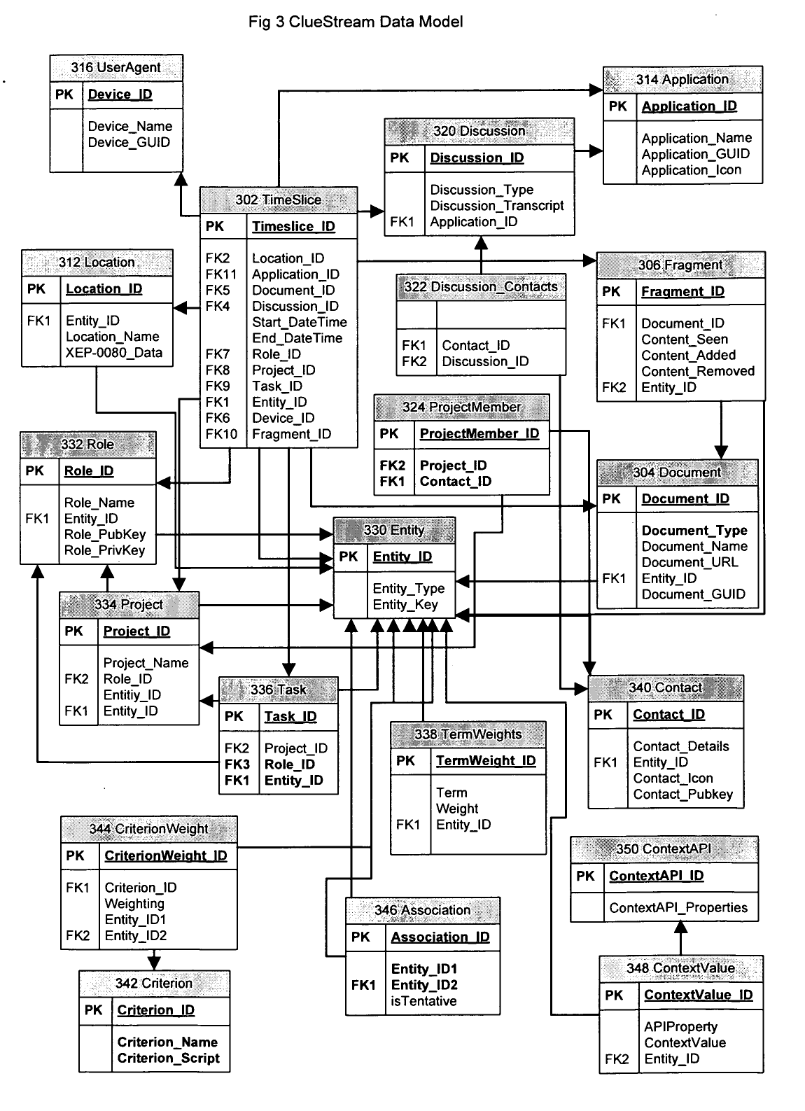

With Reference to FIG. 3

This is the data model for the system

A Timeslice represents the activity that a user was performing at a given time.

Device: The device name provided by the user—eg “My PDA” or “My Work Desktop”. Ideally it will also have some form of GUID (Globally Unique ID) that can be used.

Applications: Each application should ideally provide a name, GUID, and Icon. A “display friendly” name may also be provided either by the user or by a lookup table.

Discussions: The user may be involved in a discussion during the timeslice, using a completely different application and/or device

The preferred implementation would allow for multiple timeslices to occupy the same timeframe, in that a meeting may occur at the same time as a phonecall in which a webpage was consulted on a browser application, while a media app played in one corner of the screen. However a simpler implementation could be to log discussionID and DocumentID as part of the same TimeSlice and ignore the possibility of more than one discussion/application being in use at the same time.

A discussion may be a meeting, a call, or an online chat. Email and other async forms of communication are an interesting case, particularly since they may cover multiple projects and even multiple roles. In such cases “fragments” are the only viable way of segmenting things out.

An Application: may be a communications device in which case Discussions may be logged against it.

Determining when one discussion starts and another ends is largely impossible, so transcripts, chatlogs and recordings should be associated with multiple discussion fragments, preferrabily automatically.

Documents. Transcripts and Fragments all have intrinsic sets of Termweights—derived from the actual text.

Roles, Projects, Tasks, Locations, Discussions and Contacts will have extrinsic termweights derived from averaging out the termweights from the timeslices they are assoicated with in the database. These sets of derived termweights will be a common feature in the criterion used to determine the likely associations between these entities.

There is a direct, user assigned relationship between Tasks, Projects, and Roles, whereby a project is assigned to a Role and a Task is assigned to a Project.

However there are also derived associatons betwen timeslices and Roles/Projects/Tasks. Whereas in any given timeslice it's a matter of the logs who you were talking to or what application/device/document you were using, the association between timeslices and Roles/Projects/Tasks are usually assumed to be “Tentative” until confirmed by the user. The mechanism of association is explained in FIG. 4).

Furthermore there may be derived or explicit associations between Contacts and R/P/T, Locations and R/P/T, Contacts and Locations, etc.

Context Values are taken from various System Context APIs that may be available. Many of these APIs may not be available, but in theory it ought to be possible to include context information relating to the user's environmental Temperature, Orientation, Acceleration, the current vehicle in use, the current music being played or media being displayed, the current IP Address, Mac address or location as derived from GPS, wireless triangulation, or derived contexts such as the time of day, date of month, distance from points of interest.

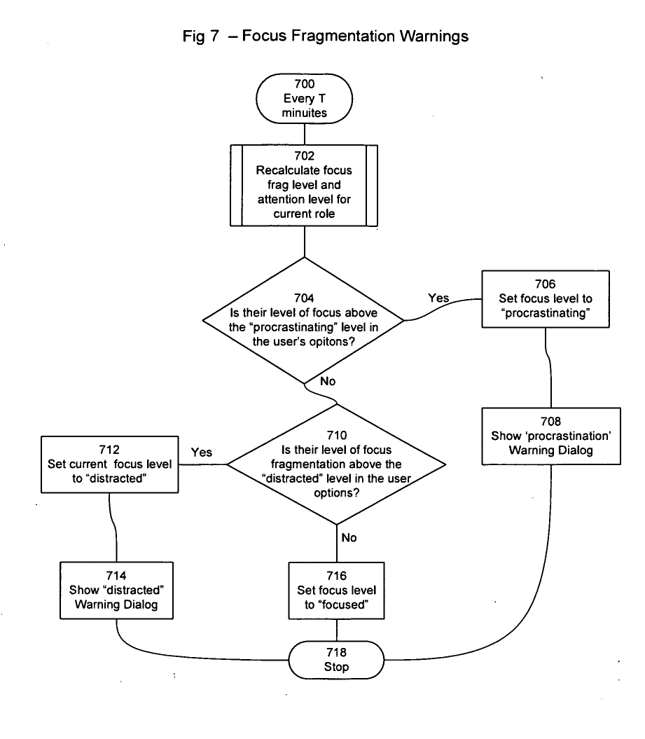

The current level of user “Focus Fragmentation” (see FIG. 7) may be a relevant context, the “time since last sleep and/or coffee” might be derivable, and even the user's “mood” or “motivation level” might be derived either from user-input, voice-analysis, or physiological sensors.

Criteria are functions/scipts/formulas that calculate a number from a function or process involving the information from two or more entities. A number of criteria may be used to judge the strength of a relationship between entities, and the relative weights of the criteria used to make the judgement may be altered when the user fails to confirm that the strongest suggestion is in fact correct. In an advanced implementation, the criterion weights may also be altered for specific contexts (See FIG. 6)

With Reference to FIG. 4

Whenever the document focused changes, a new conversation starts, or some other context of note changes, the current Timeslice is saved to the database and a new Timeslice is formed. This new timeslice 402 is then evaluated to see whether the user has changed R/P/T. If it's a document and already associated with a R/P/T 404, and that R/P/T is the same as the user's current R/P/T 406, then show an unobtrusive alert 432 to confirm user is still on the same track and assume Yes after ˜10 seconds. If the user doesn't cancel 434, then remove the tentative marker from the timeslice 435.

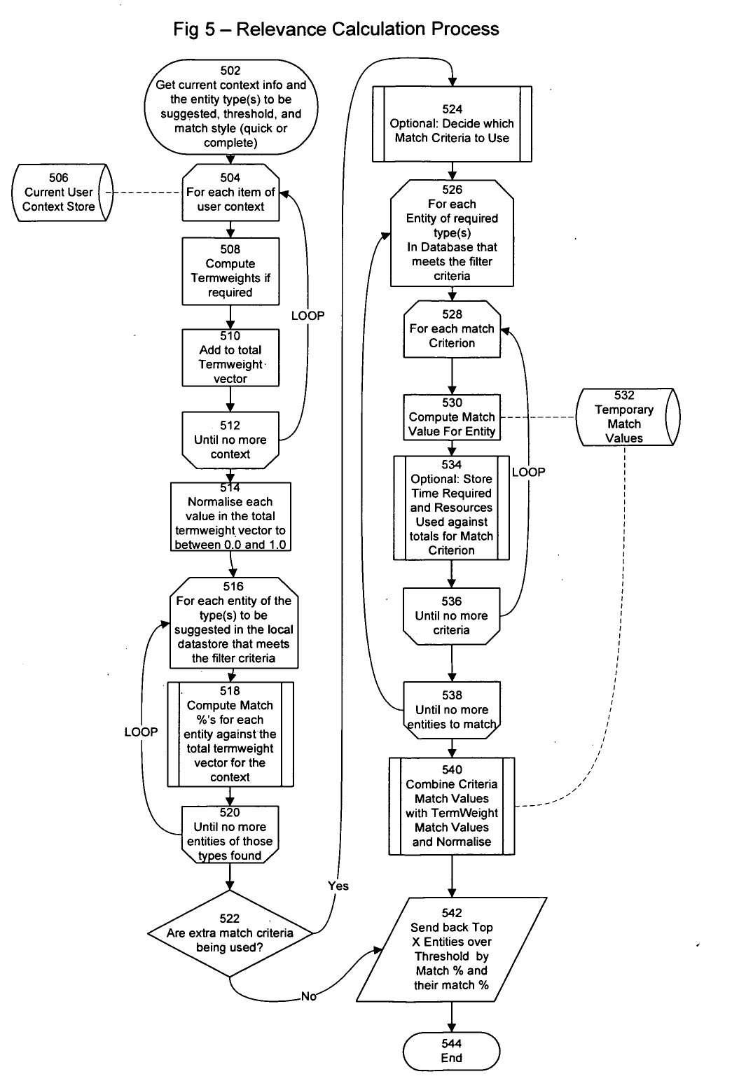

With Reference to FIG. 5

There is a subsystem dedicated to figuring out the mostly likely contacts, projects, roles, etc, that match the current context, and giving a list to the user to choose from. The request coming into the subsystem may be made for an individual entity type or for several.

With Reference to FIG. 6

If the user makes a choice that is not the expected one, it is possible to adjust the weightings on the criteria used to make the choice, such that the selection process might be more accurate in future. This training process does not occur as the result of Timeslices that are still marked “Tentative”. In an advanced implementation, the criterion weights may also be altered for specific contexts.

With Reference to FIG. 7

To aid the user in maintaining their focus, warning dialogs should be created when they are switching tasks too often. This diagram shows the system and method.

700: Every (T=Time Interval) minutes, recalculate the user's focus level 702 using a formula such as:

Focus Frag Level=T/(X(Number of tasks started/continued and not completed)+Y(Number of projects started/continued end not completed)+Z(Number of Role Switches))

And if the fragmentation level is 704 above the Procrastination level then set the current Focus level to “Procrastinating” 706 and show an alert 708 along the lines of:

“WARNING: YOU ARE PROCRASTINATIING”. Here's a list of things you ought to be doing. Pick one!

If the fragmentation level is not at the level of procrastination but is still showing signs of distractedness 710 then instead set the focus level to “distracted” 712 and show a “distraction” alert 714 along the lines of:

“HEY: YOU SEEM A BIT DISTRACTED. Why not pick [one of the things you've been working on] [one of these high priority tasks] and stick to it for a while? Do you want me to stop checking for incoming messages for a while?”

Otherwise, set the Focus level to “Focused” 716.

Aspects of the present invention have been described by way of example only and it should be appreciated that modifications and additions may be made thereto without departing from the scope thereof.

What is claimed is:

1. A method for constructing a timeline of user activity including multiple contexts and semantic associations with a user's roles, projects and tasks which comprises:
Gathering data from multiple applications, APIs, operating systems and devices in order to record information regarding user location, application and device in use, discussions and discussion members, documents “touched” and document fragments read, written, selected, edited or searched for within specific time periods referred to as Timeslices;
Derivation of weighted keyword/phrase lists from the documents, transcripts and document fragments associated with the Timeslices referred to as Termweights;
Using a weighted list of criteria matching rules for inferring the most likely Role/Project/Task (RPT) from a set of possibilities using the Timeslice context information and associated Termweights;
Optionally, monitoring the performance of criteria scripts and updating them from a central server for the purpose of finding criteria that are both effective and efficient to calculate on the user's system;
Optionally, Storing information relating to personal matters using a different encryption key to information relating to work matters, thereby allowing for user privacy and the use of a single machine for both work and play;
Using a realtime feedback system to allow the user to confirm/correct inferences and to create new RPTs as appropriate, preferably giving the user a choice between the most likely alternatives for single-click ease of operation;
Using a retrospective review system to allow for confirming or correcting automated inferences by the user at a later stage;
Building up of profiles of associated Termweights and other contexts such as time, date and location for each RPT, where the profiles are much more greatly affected by confirmed inferences and new additions than they are by unconfirmed inferences; and
Re-weighting the inference criteria when user feedback indicates incorrect inferences were made, in favor of criteria that would have led to a correct inference.
